(19) United States
(12) Patent Application Publication
(10) Pub. No.: US 2010/0181151 A1
(43) Pub. Date: Jul. 22, 2010

(54) Hybrid piston bushing sleeve assembly

(75) Inventors: Douglas S. Bingham, JR., Gilbert, AZ (US); David Kaczynski, South Bend, NJ (US)

Correspondence Address: HONEYWELL/BSKB;PATENT SERVICES, 101 COLUMBIA ROAD, P.O. BOX 2245, MORRISTOWN, NJ, 07962-2245, US

(73) Assignee: HONEYWELL INTERNATIONAL INC.

(21) Appl. No.: 12/320,274

(22) Filed: Jan. 22, 2009

(51) Int. Cl. F16D 55/10

(52) U.S. Cl. 188/72.4

(57) ABSTRACT

An apparatus for hybrid piston bushing sleeve assembly for an aircraft brake assembly includes a composite body; and a sacrificial sleeve coupled to said composite body, wherein the sacrificial sleeve is replaceable.

### FIELD OF THE INVENTION

This invention relates to an apparatus for providing braking for an airplane. The apparatus of the present invention is a hybrid piston bushing sleeve assembly suitable for aircraft brake assemblies in aircraft landing systems.

### BACKGROUND OF THE INVENTION

Typically, aircraft brake assemblies contain piston and bushing assemblies placed inside piston housing assemblies to supply hydraulic fluid for brake actuation. When the brake is applied, hydraulic pressure passes through the passageways of the piston housing assemblies actuating piston and bushing assemblies forcing the internal piston out. This squeezes the carbon heat stack together which ultimately provides braking for the airplane.

When an oil film on a cylinder of the piston bushing assembly is pressurized, the surfaces of the piston and the cylinder may actually touch. If the piston and cylinder do come in contact, scraping may take place between them which can cause marks to remain on the piston and cylinder or can even cause parts of the piston or cylinder to become scraped off. This scraping, also called scoring, results in a high rate of replacement of the entire piston and bushing assembly, which can be become expensive. The cost for materials is also expensive as well.

Moreover, weight penalties are imposed upon new programs due to forced maximum guaranteed weight. Therefore, the more a piston and bushing assembly and its components parts weigh, the more weight penalties must be paid.

### SUMMARY OF THE INVENTION

An embodiment of the present invention is directed to an apparatus for hybrid piston bushing sleeve assembly for an aircraft brake assembly includes a composite body; and a sacrificial sleeve coupled to said composite body, wherein the sacrificial sleeve is replaceable.

### BRIEF DESCRIPTION OF THE DRAWINGS

The present invention will be more fully understood by reference to the detailed description given hereinbelow and to the accompanying drawings. The drawings are not to scale, and are provided by way of illustration only. The drawings do not in any way limit the present invention.

FIG. 1 illustrates an aircraft landing gear to which principles of the present invention can be applied;

FIG. 2 illustrates a cross-sectional view of the hybrid piston bushing sleeve assembly.

FIG. 3 illustrates another cross-sectional view of the hybrid piston bushing sleeve assembly.

### DETAILED DESCRIPTION OF THE INVENTION

An embodiment of the present invention is directed to an apparatus for hybrid piston bushing sleeve assembly for an aircraft brake assembly includes a composite body; and a sacrificial sleeve coupled to said composite body, wherein the sacrificial sleeve is replaceable.

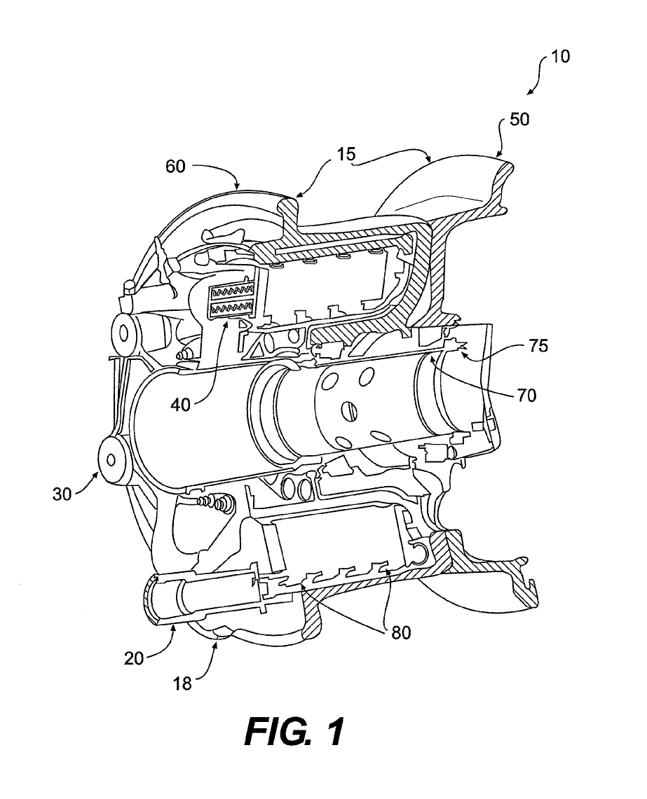

FIG. 1 illustrates an exemplary aircraft landing gear to which principles of the present invention can be applied. Aircraft landing gear is designated generally by reference numeral 10 and includes main wheel assembly 15. Main wheel assembly 15 provides a damping interface for brake-induced vibration, and is connected with a brake assembly 30. Located within the main wheel assembly 15 piston is brake assembly 30 and piston and bushing assembly 40.

Main wheel 15 includes an outboard wheel half 50 and an inboard wheel half 60. Piston and bushing assembly 40 includes therein a plurality of piston assemblies and adjuster mechanisms (not shown) and is located about main wheel assembly 15 and brake assembly 30. Axle sleeve 70 and axel nut 75 mesh with piston and bushing assembly 40 such that piston and bushing assembly 40 is connected non-rotatably thereto.

A plurality of carbon rotors and stators 80 are places within main wheel assembly 15. The heat stack contains these rotors and stators 80 such that rotors are rotated by beams and stators are keyed to a torque tube (not shown). The torque tube rests on two bearing surfaces on an axle sleeve, and remains stationary because of tie bolts that connect the torque tubing to the piston housing (not shown). The piston housing contains a torque takeout arm 18 which is grounded to the landing gear by a torque takeout pin 20.

During operation of a brake assembly 30, for example a hydraulic brake, hydraulic pressure is transmitted to the plurality of pistons which are displaced axially toward wheel to compress the rotating rotors between the stationary stators and thrust cone (not shown). The compression of the rotors between the stators retards and terminates the rotation of the rotors, drum drive and wheel to effect braking of the wheel and tire (not shown).

The piston and bushing assembly 40, which houses two piece piston bushings, has passageways (not shown) to supply hydraulic fluid to each assembly. Typically, when the brake is applied, hydraulic pressure is passed through the left end of the piston and bushing assembly and forces the piston out to the right (not shown). This squeezes the carbon heat stack together which ultimately provides braking for the airplane.

When an oil film on a cylinder of the piston bushing assembly is pressurized, the surfaces of the piston and the cylinder may actually touch. If the piston and cylinder do come in contact, scraping may take place between them which can cause marks to remain on the piston and cylinder or can even cause parts of the piston or cylinder to become scraped off. This scraping, also called scoring, results in a high rate of replacement of the entire piston and bushing assembly, which can be become expensive. The cost for materials becomes expensive as well.

Moreover, weight penalties are imposed upon new programs due to forced maximum guaranteed weight. Therefore, the more a piston and bushing assembly and its components parts weigh, the more weight penalties must be paid.

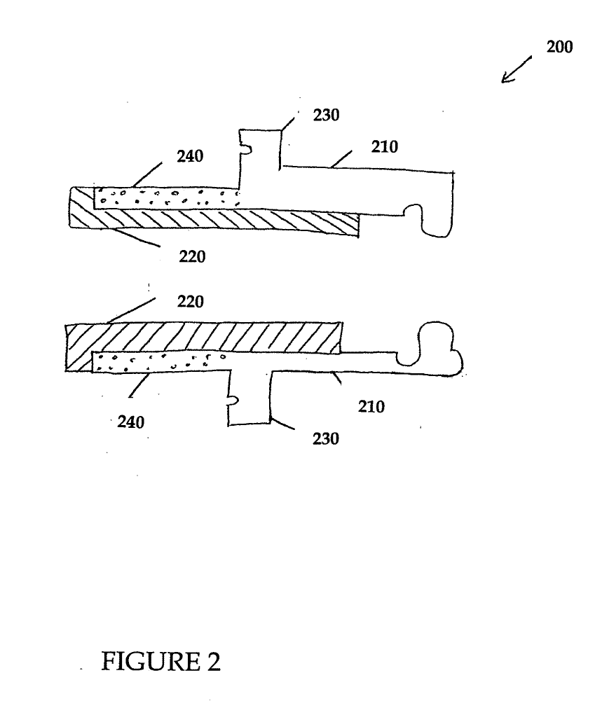

FIG. 2 illustrates hybrid piston bushing sleeve assembly 300 according to an embodiment of the present invention. Hybrid piston bushing sleeve assembly 300 includes composite body 310 and sacrificial sleeve 320. Composite body 310 is made of PEEK (injection molded composite) or similar composite material such as ultem and torlon or thermoplastic or thermal set. Composite body 310 also includes flange 330 and threaded insert 340. In another embodiment of the present invention (not shown), the flange is formed as part of the sacrificial sleeve instead of the composite body of the hybrid piston bushing sleeve assembly.

Composite body 310 of hybrid piston bushing sleeve assembly 300 can be compression or injection molded. Composite body 310 is molded onto threaded inserts 340 which engage the piston housing. Machining aluminum parts and molding composite parts is a common manufacturing practice and so it will not be further detailed.

Once composite body 310 is molded onto threaded inserts 340, sacrificial sleeve 320, made of aluminum alloy or stainless steel extrustions from sheet or tube stock, is inserted into the inner diameter of the body. Sacrificial sleeve 320 recreates the current interface with the piston. Therefore, when scoring occurs on sacrificial sleeve 320, it can be replaced without replacing the entire hybrid piston bushing sleeve assembly 300. Thus, the sacrificial sleeve 320 is designed to be sacrificial (i.e. replaceable) and repairable, therefore reducing the expense from replacing the entire hybrid piston bushing sleeve assembly 300.

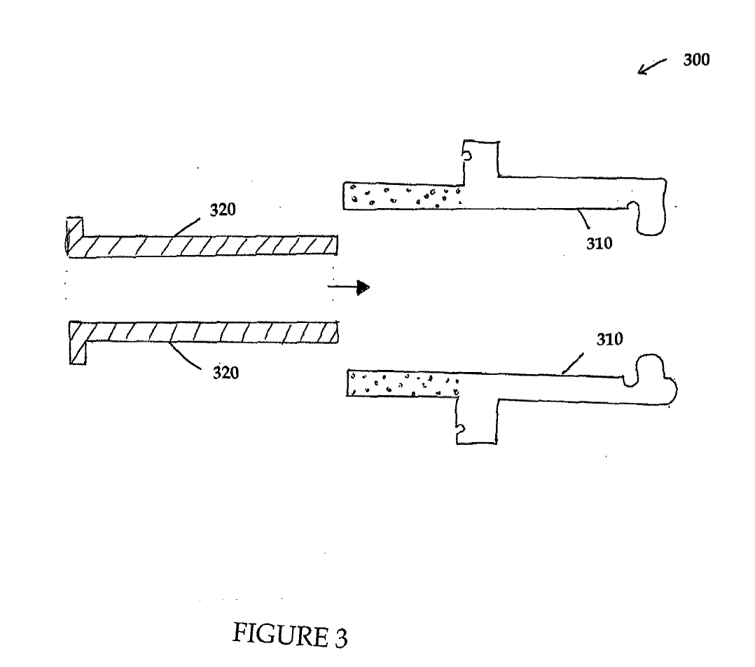

As shown in FIG. 3, the sacrificial sleeve 420 slides into and is trapped on composite body 410 of hybrid piston bushing sleeve assembly 400.

While the present invention has been described with respect to a detailed example of its implementation, the invention is capable of numerous modifications, rearrangements, and alterations, and such are intended to be within the spirit and scope of the disclosure and claims.

What is claimed is:

1. A hybrid piston bushing sleeve assembly for an aircraft brake assembly, comprising:
a composite body; and
a sacrificial sleeve coupled to said composite body,
wherein said sacrificial sleeve is replaceable.

2. The hybrid piston bushing sleeve assembly according to claim 1, wherein composite body is made of PEEK.

3. The hybrid piston bushing sleeve assembly according to claim 1, wherein composite body is made of composite material including thermo-plastic or thermal set.

4. The hybrid piston bushing sleeve assembly according to claim 1, wherein sacrificial sleeve is made of aluminum alloy or stainless steel extrustions.

5. The hybrid piston bushing sleeve assembly according to claim 1, wherein sacrificial sleeve is made of aluminum alloy or stainless steel extrustions from sheet or tube stock.

6. The hybrid piston bushing sleeve assembly according to claim 1, wherein said composite body is molded onto threaded inserts.

7. The hybrid piston bushing sleeve assembly according to claim 1, wherein the sacrificial sleeve slides into and is trapped on the composite body.

8. The hybrid piston bushing sleeve assembly according to claim 6, wherein the composite body is compression or injection molded onto said threaded inserts.

9. The hybrid piston bushing sleeve assembly according to claim 6 or 8, wherein the threaded inserts which engage the piston housing.

10. The hybrid piston bushing sleeve assembly according to claim 1, wherein the composite body includes a flange.

11. The hybrid piston bushing sleeve assembly according to claim 1, wherein the sacrificial sleeve includes a flange.

12. The hybrid piston bushing sleeve assembly according to claim 1, wherein the sacrificial sleeve is replaced when scoring occurs.
